(19) United States
(12) Patent Application Publication
(10) Pub. No.: US 2009/0055242 A1
(43) Pub. Date: Feb. 26, 2009

(54) CONTENT IDENTIFICATION AND CLASSIFICATION APPARATUS, SYSTEMS, AND METHODS

(76) Inventors: Gaurav Rewari, Cupertino, CA (US); Sadanand Sahasrabudhe, Gaithersburg, MD (US); Abhimanyu Warikoo, New york, NY (US); David Cooke, Lost Altos, CA (US); Michael D. Prospero, San Mateo, CA (US); Xiang Yu, Clarksville, MD (US); Ranjeet S. Bhatia, San Mateo, CA (US); Sailesh Kumar Das Gandham, New Delhi (IN)

Correspondence Address: SCHWEGMAN, LUNDBERG & WOESSNER, P.A., P.O. BOX 2938, MINNEAPOLIS, MN, 55402, US

(21) Appl. No.: 11/844,796

(22) Filed: Aug. 24, 2007

(51) Int. Cl. G06F 17/30; G06Q 99/00

(52) U.S. Cl. 705/10

(57) ABSTRACT

Embodiments herein relate market entities, market topics, and market relationships in a market relationship module (MRM). The MRM is used to index individually relevant information content and to formulate queries for later retrieval and presentation of the relevant content. Other embodiments are described and claimed.

### RELATED APPLICATIONS

This disclosure is related to pending U.S. patent application Ser. No. ______, titled “Content Classification and Extraction Apparatus, Systems, and Methods,” attorney docket No. 2478.003US1, filed on Aug. 24, 2007, assigned to the assignee of the embodiments disclosed herein, firstRain Inc., and is incorporated herein by reference in its entirety.

### TECHNICAL FIELD

Various embodiments described herein relate to information access generally, including apparatus, systems, and methods associated with user-relevant information content extraction.

### BACKGROUND

The term “market intelligence” refers generally to information that is relevant to a company's markets. Market intelligence may include information about competitors, customers, prospects, investment targets, products, people, industries, regulatory areas, events, and market themes that affect entire sets of companies.

Market intelligence may be gathered and analyzed by companies to support a range of strategic and operational decision making, including the identification of market opportunities and competitive threats and the definition of market penetration strategies and market development metrics, among others. Market intelligence may also be gathered and analyzed by financial investors to aid with investment decisions relating to individual securities and to entire market sectors.

With the explosion of the Internet as a means of reporting and disseminating information, the ability to obtain timely, relevant, hard-to-find intelligence from the World Wide Web (“Web”) has become central to many market intelligence initiatives. This may be particularly important to financial services investment professionals because of government-mandated restrictions on the preferential sharing of information by company management. These issues have resulted in an increased interest in applying technology to provide differentiated data and insights from web-based sources in order to yield trading advantages for investors.

However, efforts to provide timely market intelligence from internet sources have been limited by the scale, complexity, diversity and dynamic nature of the Web and its information sources. The Web is vast, dynamically changing, noisy (containing irrelevant data), and chaotic. These characteristics may confound analytical methods that are successful with structured data and even methods that may be successful with unstructured content found on enterprise intranets.

Unlike structured data in a database, web information tends not to conform to a fixed semantic structure or schema. As a result, such information may not readily lend itself to precise querying or to directed navigation. And unlike most unstructured content on corporate intranets, data on the Web may be far more vast and volatile, may be authored by a much larger and varied set of individuals, and in general may contain less descriptive metadata (or tags) capable of exploitation for the purpose of retrieving and classifying information.

Existing approaches to internet searches are designed to support a wide cross-section of users seeking content across the breadth of all human knowledge. These approaches may not support the specialized needs of market intelligence users. Shortcomings may include the poor quality of the search results as measured by precision and recall, the ineffectiveness of a keyword-based search paradigm in uncovering market intelligence, and the limited ability to place returned results in a context suitable for strategic or investment decision-making.

For example, consider a market intelligence query comprising a search for management departures from a particular company in the last six months. Such a query performed by a major internet search engine may not be restricted to management departures from the particular company and may therefor suffer from poor precision. Returned results may exclude some management departures known to exist on the Internet. This may result in poor recall. The latter problem may be caused by certain websites not being included in the results at all, a condition termed “lack of completeness.” The problem may also be characterized by the most recent management departures not being included in the results, a condition termed “lack of freshness.” The latter condition may occur even if the most recent management departures are mentioned in sites that are indexed by the search engine.

### BRIEF DESCRIPTION OF THE DRAWINGS

FIG. 1A illustrates an example apparatus and system according to various embodiments of the invention.

FIG. 1B illustrates an example market entity index in relation to a series of example content segments.

FIGS. 2A-2D illustrate example market entities and market topics in representative market relationships with one another according to various embodiments of the invention.

FIG. 3 is a data plane diagram conceptualizing market relationships created by various embodiments of the invention.

FIGS. 4A and 4B are flow diagrams illustrating example methods according to various embodiments of the invention.

FIG. 5 is a block diagram of a computer-readable medium according to various embodiments of the invention.

### DETAILED DESCRIPTION

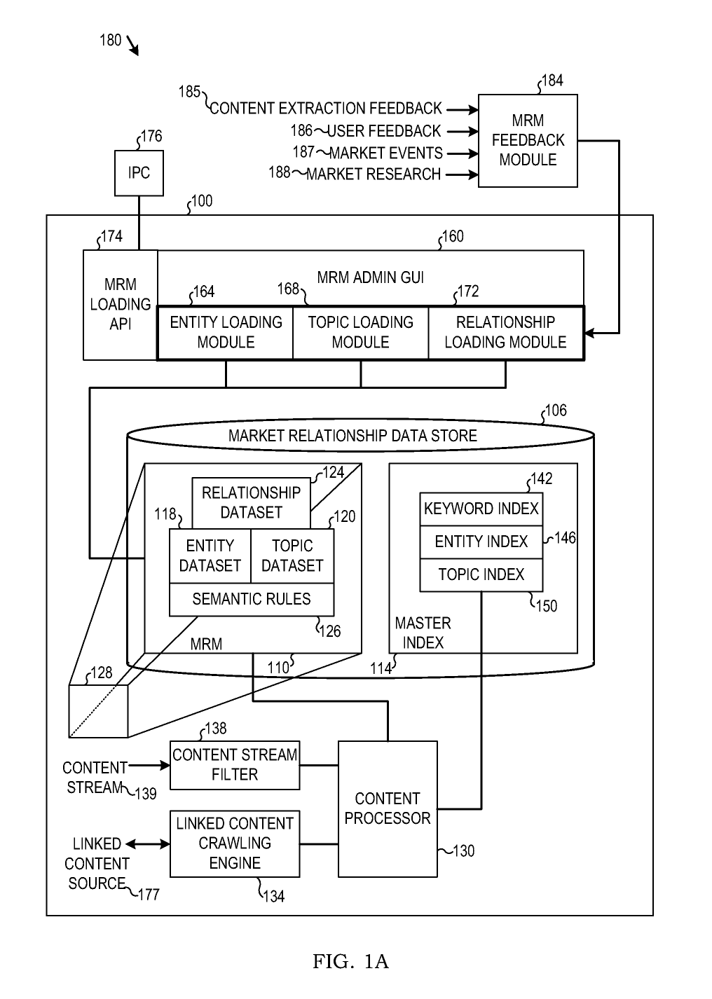

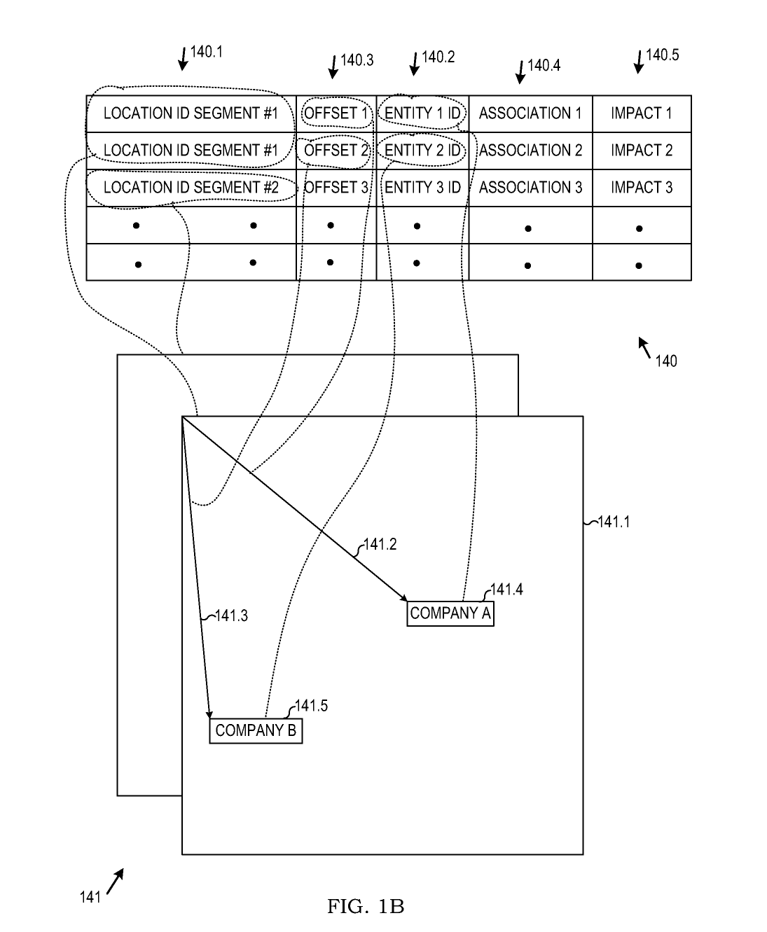

FIG. 1 illustrates an example apparatus 100 and system 180 according to various embodiments of the invention. Example embodiments described herein identify and categorize unstructured data according to a user's specific needs and interests. Various embodiments operate to create an information relationship model (IRM) of market relationships between market entities and market topics. The IRM is then used to search a source of unstructured data for content segments containing information pertaining to relevant market entities and market topics. The IRM may also be used in categorizing selected content segments by market entity, market topic, and keyword, and may source lists of market entities and market topics in response to queries.

Some embodiments may compute a strength-of-association metric to quantify a strength-of-association between a content segment and a market entity or a market topic. Some embodiments may also compute an impact metric to quantify a market impact of information contained in a content segment on a market entity or a market topic.

The relevant market entities, market topics, and keywords are then indexed along with locations within the content segments where the market entities, market topics, and keywords may be found. Queries, including queries formulated using elements from the IRM, may be executed against the relevant content index. Using these structures, the embodiments operate to timely match information to interests in a scalable manner. In particular, embodiments herein may increase precision and recall as compared to previously-known methods. “Precision” as used herein means the proportion of retrieved and relevant documents to all documents retrieved:

$$precision = \frac{\vert \{ relevant documents \} ⋂ \{ retrieved documents \} \vert}{\vert \{ retrieved documents \} \vert}$$

“Recall” as used herein means the proportion of relevant documents that are retrieved, out of all relevant documents available:

$$recall = \frac{\vert \{ relevant documents \} ⋂ \{ retrieved documents \} \vert}{\vert \{ relevant documents \} \vert}$$

Embodiments may be described herein in the context of specific examples or lists of market entities, market topics, and market relationships. Some such market relationships may be of a business or financial nature. It is noted that such examples and lists are not exhaustive. Many other market entities, market topics, and market relationships associated with various subjects and with various information content sources are comprehended by the disclosed embodiments, as will be apparent to those skilled in the art.

It is also noted that a “market entity” as described herein may comprise one or more other entities or sub-entities. For example, the term “Federal Reserve Bank” may refer to the central banking system in the United States or to an individual Federal Reserve Bank in one of the twelve Federal Reserve districts. Thus, the singular use of “market entity” is not to be taken in a limiting sense.

The apparatus 100 includes a market relationship data store (MRDS) 106. The MRDS 106 may include a market relationship module (MRM) 110 and a master index 114. The MRM 110 may comprise one or more of a relational database, an eXtensible Markup Language (XML) schema, an object oriented database, a semantic database, or a resource description framework (RDF) data store. In some embodiments the MRM 110 may include a market entity dataset 118, a market topic dataset 120, a market relationship dataset 124, and a set of semantic rules 126.

The MRM 110 relates a plurality of market entities, a plurality of market topics, and/or one or more market entities to one or more market topics according to one or more market relationships. In some embodiments a user-defined “view” 128 may be defined as a subset of the MRM 110, as described further below. Such views may include particular market entities, market topics, and market relationships of interest to a particular user and may thus serve to personalize the scope and specificity of content delivered to particular users.

The market entities, market topics, and market relationships included in the MRM 110 may be initially identified and subsequently updated through market research. Such research may include but is not limited to reading and extracting information from analyst reports and management commentaries.

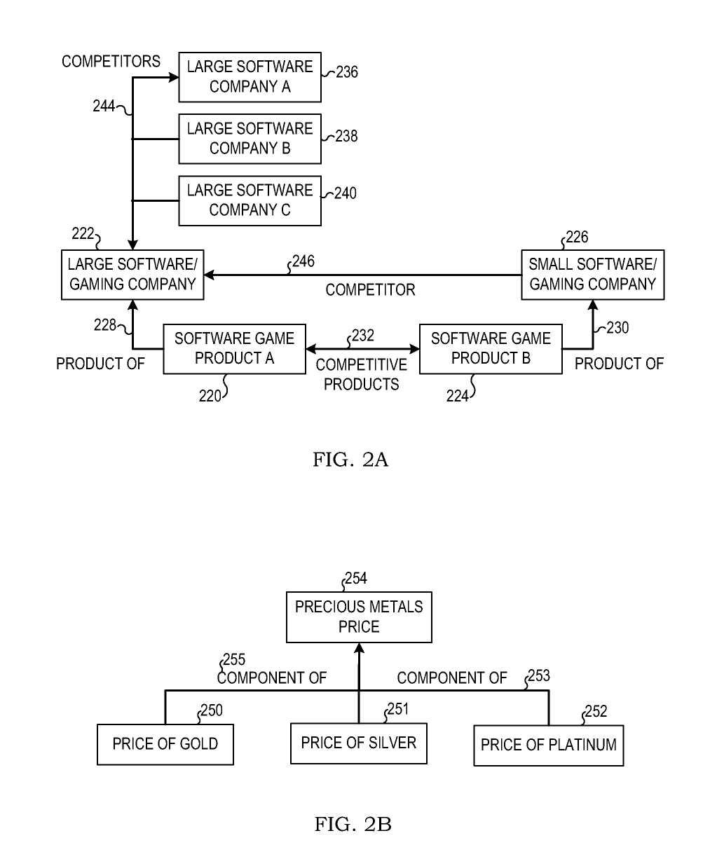

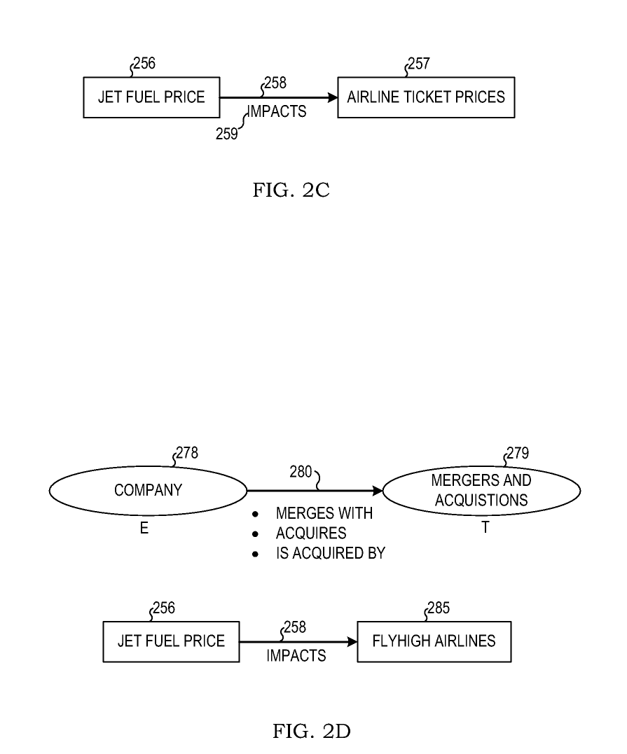

FIGS. 2A-2D illustrate example market entities and market topics in representative market relationships with one another according to various embodiments of the invention. Market relationships contemplated herein may exist between two or more market entities, between two or more market topics, or between one or more market entities and one or more market topics. The market entities, market topics, and market relationships depicted herein are merely examples of the many varied market entities, market topics, and market relationships that may be included in the MRM 110 according to various embodiments and as needed by various users. Text strings mentioned in the foregoing examples may be, but need not be, used by various embodiments to parse relevant content from a set of content segments.

FIG. 2A shows an example set of market entities and market relationships. Some market relationships may be unidirectional and some bidirectional. Embodiments herein utilize the property of directionality of market relationships to more accurately model real-world market relationships. For example, the software game product A 220 is a product of a large software and gaming company 222. The software game product B 224 is a product of a small software gaming company 226. These market relationships are represented by the unidirectional arrows 228 and 230. The software game products 220 and 224 exist in a “competitive products” market relationship with each other, represented by the bidirectional arrow 232.

The large software and gaming company 222 and the large software companies 236, 238, and 240 are competitors. Analyzed from the perspective of the large software and gaming company 222, the large software companies 236, 238, and 240 are important competitors. Analyzed from the perspective of the large software companies 236, 238, and 240, the large software and gaming company 222 is an important competitor. These competitive market relationships are represented by the bidirectional, multi-headed arrow 244. On the other hand, the small software and gaming company 226 is not considered by the large software and gaming company 222 as a significant competitor. From the perspective of the small software and gaming company 226, however, the large software and gaming company 222 is a significant competitor. The unidirectionality of this competitive market relationship is represented by the arrow 246.

Embodiments herein may treat market relationships between market topics as hierarchical or associative. For example, FIG. 2B shows that the price of gold 250, the price of silver 251, and the price of platinum 252 may lie in a hierarchical market relationship 253 with a precious metals price 254. The precious metals price 254 may comprise the price of gold 250, the price of silver 251, and the price of platinum 252. The market relationship 253 may be represented by the text string “component of” 255 or similar.

FIG. 2C is an example of an associative market relationship between market topics according to embodiments herein. Jet fuel price 256 may increase, resulting in an increase in airline operating costs. The airlines are likely to pass such cost increases on to airline customers in the form of higher airline ticket prices 257. The market topics jet fuel price 256 and airline ticket prices 257 are related in this example by the market relationship 258. The market relationship 258 may be represented by “impacts” 259 or a similar text string.

A market entity may also be related to a market topic according to a market relationship. For example, turning to FIG. 2D, a company 278 may be related to the corporate market topic “mergers and acquisitions” 279 according to a market relationship 280. The market relationship 280 may be represented by the text strings “merges with,” “acquires,” or “is acquired by.” In a further example, the market topic “jet fuel price” 256 may be related to an example market entity “Flyhigh Airlines” 285 according to the market relationship “impacts” 258.

Market relationships contemplated by the various embodiments may be static or dynamic. Static market relationships may be established by loading market relationship data structures into the MRM 110 prior to initiating relevant content retrieving operations as described hereinunder. The MRM 110 may be configured to store dynamic market relationships established “on-the-fly” in response to market events or to a frequency of occurrence of particular entities or topics as relevant content is retrieved after initially loading the MRM 110. A market event as used herein means an occurrence at a given place and at a given time relating to a market entity or to a market topic, wherein the occurrence is sufficiently noteworthy to warrant some degree of coverage on the Internet.

Assume that an example web search engine company competes in the marketplace with other web search engine companies. These web search engine companies may be related by the MRM 110 as competitors. The example web search engine company may be unrelated by the MRM 110 to any company in the market relationship of “competitor” other than the web search engine competitors. Subsequently a “market event” such as the acquisition of a security software company by the example web search engine company may occur. This may necessitate a revision of the MRM 110 to include security software companies as competitors.

A particular market entity or topic may not currently be related by the MRM 110 to a “primary” market entity. Some embodiments may track the frequency with which the particular market entity or topic is found in content segments referencing the primary market entity. Embodiments so equipped may create an on-the-fly market relationship between the primary market entity and the particular market entity or topic in the MRM 110. The MRM 110 may be configured to store a dynamic market relationship established if the frequency of coincidence between two market entities, two market topics, or a market topic and a market entity found in one or more content segments associated with a content stream increases past a selected threshold.

The MRM 110 may also be configured to store a new market entity or market topic synthesized from two or more existing market entities and/or market topics. The market entities and/or market topics may appear within a particular context. In some embodiments the market entities and/or market topics may be provided at query time.

For example, consider a market topic of “management departures” and a market entity “Company A.” Querying using the logical AND of this market topic-market entity combination returns content segments related to both “management departures” and “Company A.” However only a subset of the returns will be on target as “management departures from Company A.”

Some embodiments herein may create a new, context dependent market topic. In this example, the new market topic is “management departures from Company A.” A query using the new market topic returns the desired targeted subset, “management departures from Company A.” The new market topic behaves like other market topics in that it is associated with a semantic rule and it gets indexed; however it is built from pre-defined market entities and market topics and their associated semantic rules stored in the MRM 110.

A new context-dependent market entity may also be created by combining two or more market entities or a market entity and a market topic. For example, the market entity “famous chief executive officer (CEO)” in context with the market entity “Company A” may result in the new market entity “famous CEO of Company A.” Likewise, the same market entity “famous CEO” in context with the market topic “philanthropy” may result in the new market entity “famous philanthropic CEO.” These logical structures enable the filtering out of results extraneous to a selected compound market entity or market topic.

Embodiments herein may identify key sets of classes for context types (e.g., management departure FROM, litigation BY, and litigation AGAINST, among others). Some embodiments may build a set of semantic rule “couplers” to couple multiple instances of an underlying market entity or market topic that is part of a new context-dependant market entity or market topic in the same way if the multiple instances share the same context type. Embodiments herein may also identify some market entities and market topics as “context capable” and may allow a user to supply the context at query time. Appropriate semantic logic may couple the market entity and/or market topic to existing semantic rules. A resulting compound, context-dependent market entity and/or market topic may then operate to categorize content segments.

A market entity may thus comprise one or more of a company, a subsidiary, a joint venture, a product brand, a service brand, a product application, a service application, a non-profit organization, an advocacy group, a region, a governmental sub-division, a person, a raw material, or a component. A market entity may also comprise a production plant or a location associated with one or more of a company, a subsidiary, a joint venture, a product brand, a service brand, a product application, a service application, a non-profit organization, an advocacy group, a region, or a governmental sub-division, among others.

A market topic may comprise one or more of a financial market topic, a corporate market topic, a macroeconomic market topic, a regulatory market topic, a geo-political market topic, or a thematic market topic, among others. Example financial market topics may include raw material prices, the credit quality of the debt of a particular corporation, and dividend rates associated with stock issued by a particular corporation, among others. Example corporate market topics may include management hires, management departures, mergers and acquisitions, and new product launches, among others. Example macroeconomic market topics may include gross domestic product (GDP) growth trends, federal interest rates, bond market yield curves, and globalization trends, among others. Example regulatory market topics may include federal tax rules for publicly-traded partnerships and foreign government regulation of direct marketing in a foreign country, among others. These examples of market topics and market topic categories are merely examples of many known to those skilled in the art and included in embodiments herein.

A market relationship between two entities may comprise one or more of customer, competitor, supplier, partner, subsidiary, parent company, merger and acquisition target, investor, regulator, banker, financier, employee, labor, lobbying group, advocacy group, industry consortium, union, management team member, director, thought leader, person of influence, financial analyst, industry analyst, division, office, plant, producer, seller, development resource, embedded resource, place of operation, key market, or location of unit, among others. A “thought leader” is a person who is a recognized authority in a particular field.

Embodiments herein also comprehend market relationships between two or more market topics and between one or more market entities and one or more market topics. A market relationship between a market entity and a market topic may derive from the methodology used to select the market entity and the market topic. The market relationship may be associated with a potential impact on the market entity of information related to the linked market topic. If the topic is constructed in a neutral way (e.g., the market topic “supply of pulp” related to a paper manufacturing market entity), the market relationship may simply comprise “important variable of,” or the like. On the other hand, if the market topic is constructed to be something like “pulp supply shortage,” the market relationship may comprise “introduces risk for,” or the like.

Considering a further example, if the market topic is related to China's relaxing import restrictions on paper then the market relationship could be “increases demand for.” Given that market topics may be selected according to their financial impact on companies, embodiments herein may create market relationships between entities and market topics along risk/reward lines. A market topic may be defined to identify documents relating to risk or reward, or the market topic may be defined neutrally.

Like market entities, market topics connect to each other hierarchically or associatively. In a hierarchical market relationship a market topic is a complete subset of the other. For example, “outsourcing to India” may comprise a child of the parent market topic “outsourcing.”

Associative market topics comprise categories that connect to each other without a parent-child market relationship necessarily applying. “Big Company's market relationships with labor” is a market topic that may be connected associatively with “Big Company's public relations (PR) initiatives” because Big Company may launch some PR initiatives to counter negative image resulting from labor relations problems.

A directionality attribute may be associated with a market relationship as illustrated in some of the market relationship examples cited above. For example, a larger company in competition with a smaller company may be seen by the smaller company as competitor, while the smaller company may not be recognized at all by the larger company.

Turning back to FIG. 1A, the apparatus 100 may also include a content processor 130 coupled to the MRM 110. The content processor 130 receives unstructured information content and parses the unstructured content into a plurality of selected content segments. Each selected content segment may comprise one or more of a content file, a portion of a content file, a tag associated with a content file, or a result of a translation operation performed on a content file. A content file may comprise one or more of a markup language page (e.g., HTML), a text file, a word processing file, a graphics file, a video file, an audio file, a spreadsheet file, a slide presentation file, or a page description file, among other file types.

Embodiments herein may relate each selected content segment to one or more selected market entities, selected market topics, and/or keywords. The content processor 130 parses and relates the selected content segments to the selected market entities and the selected market topics according to a set of semantic rules 126 stored in the MRM 110. The set of semantic rules 126 identifies market entities and market topics in a content segment using a variety of semantic classification techniques known to those skilled in the art, including but not limited to statistical, probabilistic, taxonomic, hierarchical, heuristic, and/or machine learning categorization techniques.

In some embodiments the content processor 130 is configured to receive a crawled plurality of content segments from a linked content crawling engine 134, a content stream filter 138, or both. In some embodiments the content processor 130 is configured to extract the selected content segment from the Internet, an intranet, a database, a library, or a content stream 139. FIG. 1B illustrates an example market entity index 140 in relation to a series of example content segments 141. The content processor 130 indexes a location identifier 140.1 associated with each selected content segment (e.g., the content segment 141.1) by an identifier 140.2 associated with the selected market entity, the selected market topic, or the keyword (e.g., the companies 141.4 and 141.5). The location identifier 140.1 may comprise one or more of a uniform resource locator (URL), a file location, or a location of a portion of a file within the file, among other location identifiers.

More specifically, the content processor 130 may be configured to associate one or more content segment offsets 140.3 with each selected market entity, market topic, or keyword. Each content segment offset 140.3 corresponds to a position of an occurrence of the selected market entity, selected market topic, or keyword (e.g., the positions 141.2 and 141.3) within the selected content segment. A content segment offset may comprise a position of a word, a sentence, a paragraph, or a section of the selected content segment.

Turning back to FIG. 1A, the apparatus 100 may also include the master index 114, as previously mentioned. The master index 114 may comprise a keyword index 142, a market entity index 146, and a market topic index 150. The master index 114 may be coupled to the content processor 130 to store the indexed location identifier and the identifier associated with the selected market entity, the selected market topic, and/or the keyword.

Each entry within the keyword index 142 includes a keyword or a keyphrase, a corresponding content location identifier, and a content segment offset. The keyword or keyphrase is extracted from one or more selected content segments. Each content segment is located at a content location corresponding to an associated content location identifier. The keyword index 142 may also include a keyword association metric value for each keyword. The keyword association metric value indicates a frequency of occurrence of the keyword in a selected content segment. The metric may also be based upon a presence of the keyword in a headline associated with the selected content segment or an occurrence of the keyword with greater prominence than surrounding text. An occurrence of the keyword in a caption associated with a picture found within the selected content segment or a presence of the keyword in anchor text may also be used to calculate the keyword association metric value.

Each entry within the market entity index 146 includes one or more of a market entity identifier, a corresponding content location identifier, and a content segment offset. The market entity identifier corresponds to a market entity identified within a selected content segment by the content processor 130 using the MRM 110. The occurrence of the identified market entity in the selected content segment implies that the identified market entity is referred to by the selected content segment. The selected content segment is located at a content location corresponding to the associated content location identifier.

Each entry in the market topic index 150 comprises one or more of a market topic identifier, a corresponding content location identifier, and a content segment offset. The market topic identifier corresponds to a market topic selected using the MRM and referred to by one or more selected content segments. Each content segment is located at a content location corresponding to an associated content location identifier.

In some embodiments the market entity index 146 and the market topic index 150 sections of the master index 114 may be configured to store strength-of-association metric values (e.g., the strength-of-association metric values 140.4 of FIG. 1B). The strength-of-association metric values correspond to the selected market entity and/or the selected market topic, respectively. A strength-of-association metric value indicates the degree of relatedness between the selected content segment and the selected market entity or the selected market topic, respectively.

The strength-of-association metric value is computed using the set of semantic rules and may be based upon a frequency of occurrence of keywords indicative of the market entity or the market topic in the selected content segment. The strength-of-association metric value may also be based upon a presence of the keywords in a headline associated with the selected content segment, an occurrence of the keywords with greater prominence than surrounding text, an occurrence of the keywords in a caption associated with a picture found within the selected content segment, or a presence of the keywords in anchor text. “Anchor text” in this context means hypertext associated with a market entity or topic which, when clicked on, takes the viewer to the selected content segment associated with the market entity or topic. “Greater prominence” in the current context means text occurring in a larger font size, underlined, italicized, center-justified, demarcated with line breaks, and/or hyperlinked, among other types of prominence-enhancing attributes.

The market entity index 146 and the market topic index 150 may also be configured to store an impact metric value (e.g., the impact metric values 140.5 of FIG. 1B). The impact metric value may be associated with an impacted market entity or an impacted market topic, respectively. The impact metric value indicates the relative importance of the selected content segment to the impacted market entity or the impacted market topic. The impact metric value is calculated using the set of semantic rules 126 and comprises a composite score. The composite score is based upon factors such as a pre-defined assessment of a financial impact of an impacting market entity or an impacting market topic found in the selected content segment on the impacted market entity or on the impacted market topic.

Other factors used to calculate the impact metric value may include an occurrence in the selected content segment of an impacting market entity or market topic pre-defined as high impact; an occurrence in the selected content segment of an impacting market entity-keyword pair, wherein the impacting market entity-keyword pair is pre-defined as high impact; an occurrence in the selected content segment of an impacting market topic-keyword pair, wherein the impacting market topic-keyword pair is pre-defined as high impact; an occurrence in the selected content segment of multiple key market entities; an occurrence in the selected content segment of multiple key market topics, and/or authorship of the selected content segment by a member of a predefined list of individuals determined through research to be at least one of a member of management, a thought leader, or an influential person in an industry.

Some embodiments herein may combine the strength-of-association metric value and the impact metric value to provide an insightful composite measure of relevance of content to a user requirement. Thus, for example, it may be insufficient in the investment analysis market to know that the subject matter contained within a content segment is strongly about Company A. It may also be important to know that the subject matter contained within a content segment impacts the financial prospects of Company A.

The apparatus 100 may also include an MRM administrative graphical user interface (GUI) 160 communicatively coupled to the MRM 110. The MRM GUI 160 is configured to receive the market entity dataset 118, the market topic dataset 120, the market relationship dataset 124, and the set of semantic rules 126. A market entity loading module 164 may be coupled to the MRM 110 to load the market entity dataset 118. The market entity loading module 164 may also load a subset of semantic rules associated with one or more market entity representations contained in the market entity dataset 118.

The apparatus 100 may also include a market topic loading module 168 coupled to the MRM 110. The market topic loading module 168 loads the market topic dataset 120 and a subset of semantic rules associated with one or more market topic representations contained in the market topic dataset 120. Likewise, a market relationship loading module 172 may be coupled to the MRM 110 to load the market relationship dataset 124. An MRM loading application programming interface (API) 174 may be coupled to the MRM 110 to load one or more of the market entity dataset 118, the market topic dataset 120, the market relationship dataset 124, or the set of semantic rules 126 from an interprocess communications source 176.

The apparatus 100 may include the linked content crawling engine 134 coupled to the content processor 130, as previously mentioned. The linked content crawling engine 134 navigates among linked content sources 177, extracts crawled content segments from the linked content sources, and presents the crawled content segments to the content processor 130. The content stream filter 138 may also be coupled as an input to the content processor 130. The content stream filter 138 extracts filtered content segments and presents the filtered content segments to the content processor 130.

In a further embodiment, a system 180 may include one or more of the apparatus 100. The system 180 may also include an MRM feedback module 184 communicatively coupled to the MRM 110. The MRM feedback module 184 may modify the MRM 110 according to feedback data 185 derived from content retrieval operations using the MRM 110 and/or from user feedback 186 based upon retrieval operations using the MRM 110. The MRM feedback module 184 may also modify the MRM 110 according to one or more market events 187 and/or market research 188, as previously described using examples above.

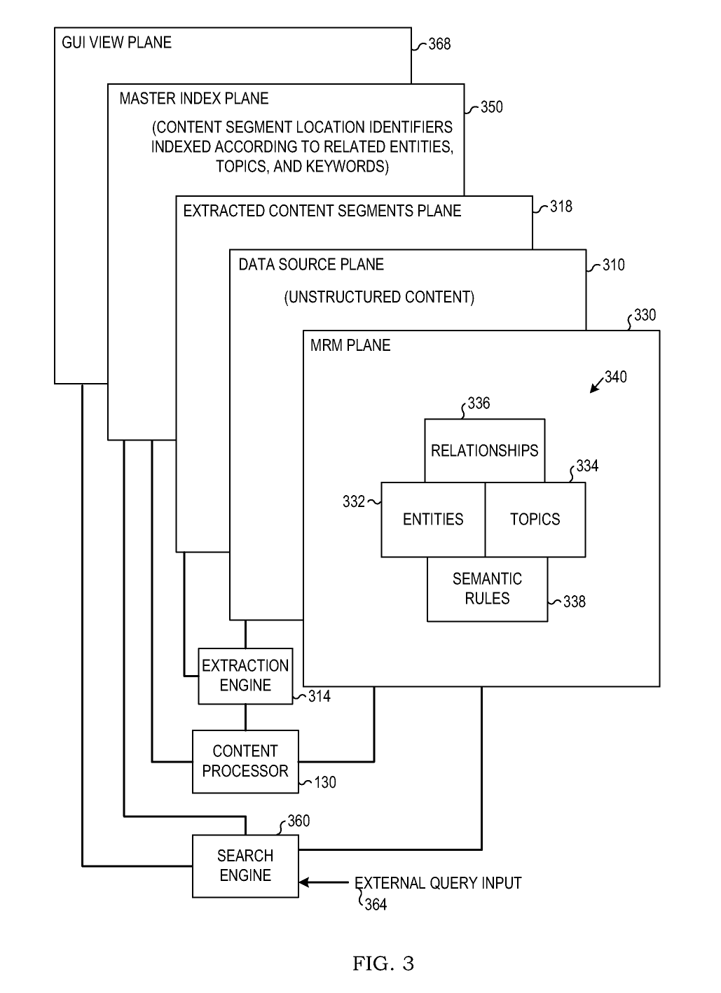

FIG. 3 is a data plane diagram conceptualizing market relationships created by various embodiments of the invention. A data source plane 310 represents a source of unstructured content from which content segments may be extracted. Such sources include the Web, one or more content files, a digitized library, and others as previously described. An extraction engine 314 extracts content from the data source plane 310 to yield information in an extracted content segments plane 318.

In an example embodiment the extraction engine 314 may comprise a web crawler (e.g., the linked content web crawling engine 134 of FIG. 1A). The information in the extracted content segments plane 318 comprises an unstructured subset of the data source plane content. In the case of web content, for example, the web crawler may be programmed to crawl a preconfigured set of websites. The web crawler may also perform basic filtering activities such as optionally removing titles, sub-headings, captions, and other page elements deemed to be of limited use in the extraction of relevant content. Content segments extracted by the extraction engine 314 are presented to the content processor 130.

An MRM plane 330 represents sets of market entities 332, market topics 334, market relationships 336, and semantic rules 338 that together form an IRM 340. The IRM 340 is used to determine which extracted content segments associated with market entities and market topics are indexed for subsequent retrieval. The IRM 340 may also optionally be used to formulate queries associated with the subsequent retrieval of indexed content segments. By customizing the IRM 340 to a specific user's content relevance requirements or to those of a particular class of users, the level of content recall, and/or precision may be increased relative to results achievable with a general search engine.

Increasing recall by including a wide set of related entities and topics may be particularly desirable when tracking a smaller entity with less coverage on the Internet and other information channels. For example, some embodiments may include related entities and topics such as competitors, competing drugs, related therapeutic areas, labs where relevant research is being done, etc. when retrieving information about a small pharmaceutical company that is seldom mentioned in the media. Similarly, increasing precision by restricting related entities, sub-entities and topics to very important ones may be useful when searching for a company with a large amount of information coverage. For example, some embodiments may include only key divisions, product lines and executives of a large, much-covered company. This may operate to ensure that what is returned for that company has a high likelihood of being relevant.

The content processor 130 searches the extracted content segments plane 318 for information related to the market entities 332 and the market topics 334 using the semantic rules 338 from the MRM plane 330. The content processor 130 indexes locations of the resulting set of selected content segments by market entity, market topic, and keyword/keyphrase in a master index represented conceptually by the master index plane 350.

A temporal dimension is associated with the data planes 310, 318, and 350. The extraction engine 314 may perform extraction operations on the data source plane 310 and perform categorization operations by populating the master index plane 350 as one phase. A search engine 360 may subsequently perform search and retrieval operations on the master index plane 350 as a second phase.

The data source plane 310 may change dynamically over time as new content is made available and as old content is taken down. The degree of synchronism between the data source plane 310 and the master index plane 350 may thus be a function of the frequency of repeated crawling of websites associated with the data source plane 310. Embodiments herein may efficiently use crawling resources by narrowing the data source plane 310 to a list of crawled sites most likely to yield relevant content according to a user's particular content requirements.

At any point in time after an initial crawling and content processing cycle is performed according to the setup of the MRM plane 330 for a new user, the search engine 360 may formulate queries to be executed against the master index plane 350. The queries may be formulated using a combination of information from the IRM 340 and external query input 364. The external query input 364 may comprise input from a user, among other sources.

Thus formulated, the query may be executed against the master index plane 350 and/or the MRM plane 330. Selected content location identifiers returned from the master index plane 350 in response to the query may then be used to access the selected content for presentation to the user at a graphical user interface (GUI) view plane 368. The same mechanisms may return and present lists of relevant market entities, market topics, and market relationships.

A query may be formulated from keywords input using a traditional keyword search input interface. Some embodiments of the invention may also selectively present sub-structures of the MRM 110 to the user as a query composition tool. For example, a list of market topics defined by the MRM 110 as related to a subject company may be presented to a browsing user. The user may select one or more market entities from the list of market entities to be used as query criteria.

The MRM 110 may also be used to query other databases at runtime using semantic rules to dynamically categorize content. The MRM 110 may also be used to filter information in real time when the source is a content stream. Queries may also be saved for later execution. Some embodiments may retrieve and execute a saved query at selected intervals. Positive responses from such periodic queries may be delivered to the user in the form of an alerting function. Alternate embodiments may provide real-time alerting when the source is a content stream.

Any of the components previously described may be implemented in a number of ways, including embodiments in software. Software embodiments may be used in a simulation system, and the output of such a system may provide operational parameters to be used by the various apparatus described herein.

Thus, the apparatus 100; the MRDS 106; the MRM 110; the master index 114; the market entity dataset 118; the market topic dataset 120; the market relationship dataset 124; the set of semantic rules 126; the game products 220, 224; the arrows 228, 230; the market relationships 253, 258, 280, 336; the market topics 279, 334; the prices 250, 251, 252, 254, 256, 257; the text string 255; the companies 278, 141.4, 141.5; the market entity 285; the content processor 130; the crawling engine 134; the filter 138; the content stream 139; the indices 140, 142, 146, 150; the content segments 141, 141.1; the location identifier 140.1; the market entity, market topic, or keyword identifier 140.2; the offsets 140.3, the positions 141.2, 141.3; the metric values 140.4, 140.5; the GUI 160; the loading modules 164, 168, 172; the API 174; the interprocess communications source 176; the system 180; and the MRM feedback module 184; the data planes 310, 318, 330, 350; the extraction engine 314; the content processor 130; the market entities 332; the semantic rules 338; the IRM 340; the search engine 360; the external query input 364; and the GUI view plane 368 may all be characterized as “modules” herein.

The modules may include hardware circuitry, optical components, single or multi-processor circuits, memory circuits, software program modules and objects, firmware, and combinations thereof, as desired by the architect of the apparatus 100 and the system 180 and as appropriate for particular implementations of various embodiments.

The apparatus and systems of various embodiments may be useful in applications other than identifying and categorizing unstructured data targeted to specific user interests and needs. Thus, the current disclosure is not to be so limited. The illustrations of the apparatus 100 and the system 180 are intended to provide a general understanding of the structure of various embodiments. They are not intended to serve as a complete or otherwise limiting description of all the elements and features of apparatus and systems that might make use of the structures described herein.

The novel apparatus and systems of various embodiments may comprise and/or be included in electronic circuitry used in computers, communication and signal processing circuitry, single-processor or multi-processor modules, single or multiple embedded processors, multi-core processors, data switches, and application-specific modules including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., MP3 (Motion Picture Experts Group, Audio Layer 3) players), vehicles, medical devices (e.g., heart monitor, blood pressure monitor, etc.), set top boxes, and others. Some embodiments may include a number of methods.

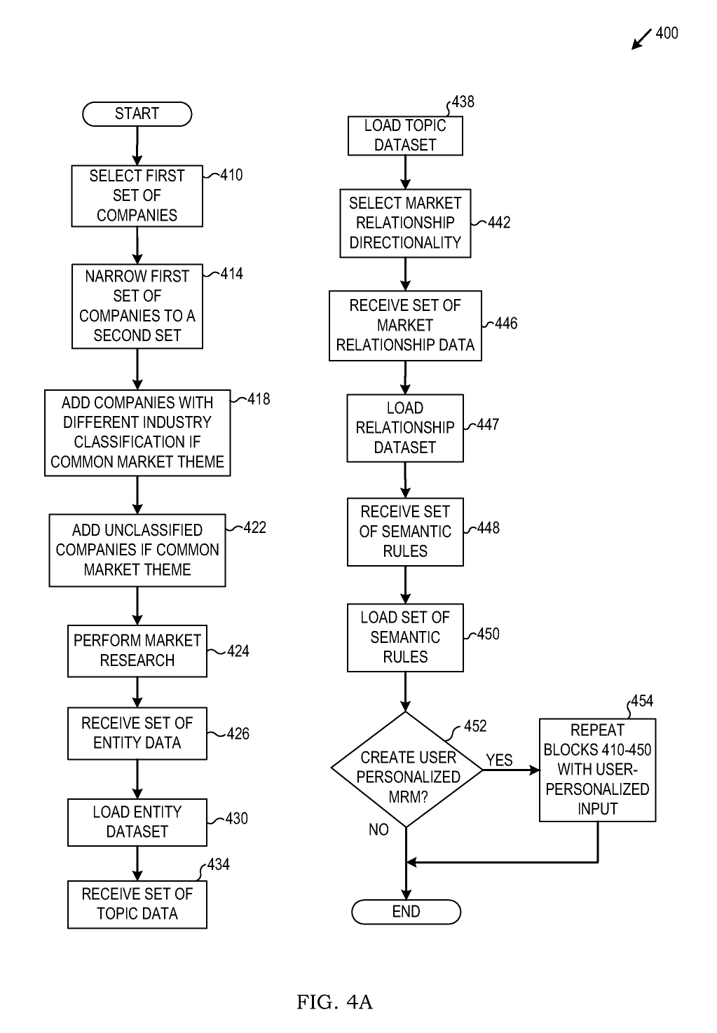

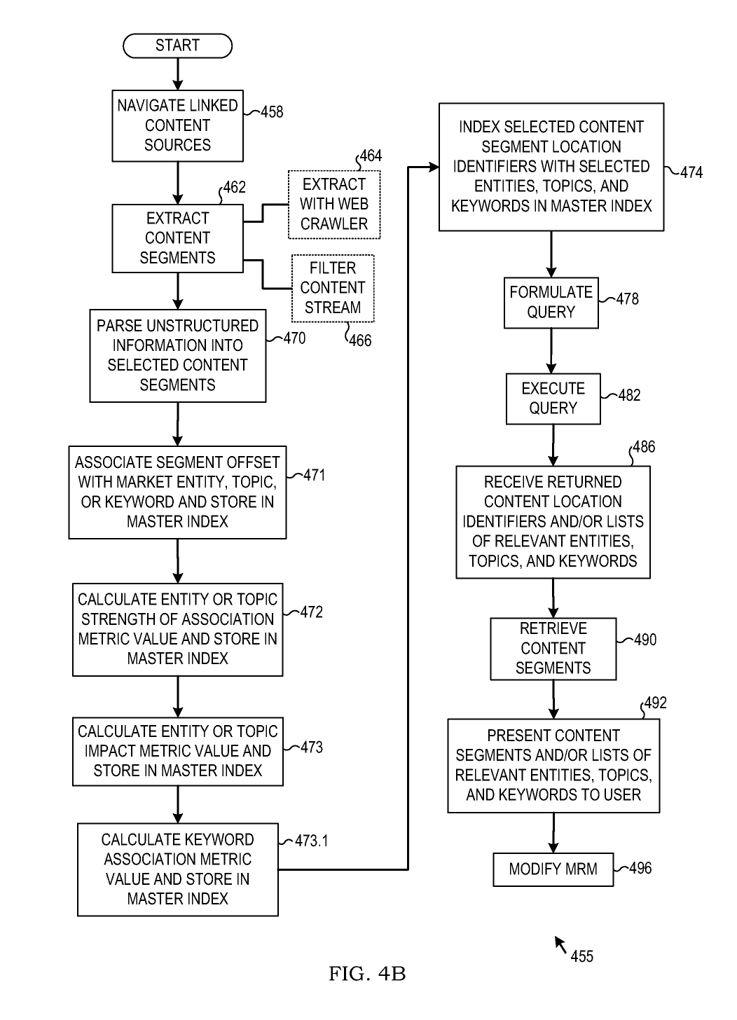

FIG. 4A is a flow diagram illustrating example methods according to various embodiments of the invention. A method 400 relates two or more market entities, two or more market topics, or one or more market entities and one or more market topics according to one or more market relationships using a market relationship module (MRM).

In an example embodiment using companies as a subset of market entities, the method 400 may commence at block 410 with selecting a first set of companies corresponding to an industry using a standard industry classification system. It is noted that a “company” as used in these examples may be a division, a department, or some other market sub-entity of a company or corporation. The method may continue at block 414 with narrowing the first set of companies to a second set of companies with a common market theme. At block 418, a company classified under a different industry may be added to the second set of companies if the company classified under the different industry shares the common market theme. An unclassified company may also be added to the second set of companies if the unclassified company shares the common market theme, at block 422. “Company” as used herein may comprise an entire holding company, one or more subsidiary companies, departments within companies, or a company presence at a particular geographical location.

The method 400 may also include performing market research associated with the second set of companies, at block 424. The market research may be targeted to determine market topics relevant to the second set of companies and to determine market relationships between the companies, between the relevant market topics, or between one or more companies and one or more relevant market topics. The market relationships may include a directionality characteristic, as previously described.

The method 400 may also include receiving a set of market entity data, at block 426, and loading a market entity dataset associated with the MRM with the set of market entity data, at block 430. The method 400 may continue at block 434 with receiving a set of market topic data. The method 400 may further include loading a market topic dataset associated with the MRM with the set of market topic data, at block 438. The method 400 may also include selectively establishing a market relationship as unidirectional or bidirectional, at block 442. The method 400 may further include receiving a set of market relationship data, at block 446, and loading a market relationship dataset associated with the MRM with the set of market relationship data, at block 447. The method 400 may also include receiving a set of semantic rules, at block 448, and loading the set of semantic rules into the MRM, at block 450.

The afore-described activities operate to populate and prepare the MRM for use in extracting and categorizing usable information from unstructured information content. Some embodiments optionally support creating a user-personalized MRM as a subset of the MRM as previously described. Thus, the method 400 may include determining whether a user-personalized MRM is desired, at block 452. If so, the method 400 may include repeating activities 410-450 with user-personalized input, at block 454. A user-personalized MRM may increase the precision and recall of information retrieval and delivery.

FIG. 4B is a flow diagram illustrating example methods according to various embodiments of the invention. A method 455 may begin content extraction by navigating among a series of linked content sources, at block 458. The method 400 may continue by extracting a plurality of content segments from the series of linked content sources, at block 462. In some embodiments the content segments may be extracted using a linked content crawling engine, including a web crawler, at block 464. Alternatively, or in addition to using a crawling engine, the method 400 may include filtering a content stream to extract the content segments, at block 466. The extracted content segments may be output from the crawling engine or from the content filter as a set of unstructured information content.

Having extracted the unstructured information content from the content source(s), these activities may proceed by using the MRM to create a master index of selected content. The method 400 may include parsing the unstructured information content into a plurality of selected content segments, at block 470. Each selected content segment may be related to a selected market entity, a selected market topic, or a keyword. The selected content segments are parsed according to logical structures within the MRM.

The method 400 may also include associating one or more content segment offset values with each selected market entity, selected market topic, or keyword, at block 471. A content segment offset in this context comprises a position of a word, a sentence, a paragraph, or a position of a section of the selected content segment within the segment. A content segment offset thus corresponds to a position of an occurrence of the selected market entity, selected market topic, or keyword within the selected content segment. Content segment offset values are stored in the master index.

The method 400 may further include calculating a strength-of-association metric value, at block 472. The strength-of-association metric value corresponds to a selected market entity or a selected market topic and indicates relatedness between the selected market entity or market topic and the selected content segment.

The strength-of-association metric value is computed using the set of semantic rules. The metric may be based upon a frequency of occurrence of keywords indicative of the market entity or the market topic in the selected content segment. The metric may also be based upon a presence of the keyword in a headline associated with the selected content segment or an occurrence of the keyword with greater prominence than surrounding text. An occurrence of the keyword in a caption associated with a picture found within the selected content segment or a presence of the keyword in anchor text may also be used to calculate the strength-of-association metric value. The strength-of-association metric value is stored in the master index.

The method 400 may also include calculating an impact metric value associated with one or more impacted market entity or market topic, at block 473. An impact metric value indicates a relative importance of the selected content segment to the impacted market entity or market topic.

The impact metric value may be calculated using the set of semantic rules. This value may comprise a composite score based upon a pre-defined assessment of a financial impact of an impacting market entity or market topic on the impacted market entity or market topic. Other factors may include an occurrence of an impacting market entity pre-defined as high impact, an occurrence of an impacting market topic pre-defined as high impact, an occurrence of an impacting market entity-keyword pair pre-defined as high impact, and/or an occurrence of multiple key market topics. Additional factors may include authorship of the selected content segment by a member of a predefined list of individuals determined through research to be members of management, thought leaders, or influential persons in an industry. The impact metric value is stored in the master index.

The method 470 may further include calculating a keyword association metric value, at block 473.1. The keyword association metric value may be associated with a keyword to indicate a frequency of occurrence of the keyword in a selected content segment. The metric may also be based upon a presence of the keyword in a headline associated with the selected content segment or an occurrence of the keyword with greater prominence than surrounding text. An occurrence of the keyword in a caption associated with a picture found within the selected content segment or a presence of the keyword in anchor text may also be used to calculate the keyword association metric value. The keyword association metric value is stored in the keyword index.

The method 400 may continue at block 474 with indexing a series of location identifiers associated with a corresponding series of selected content segments in the master index. Each content location identifier is associated in a market entity index, a market topic index, or a keyword index subset of the master index with the selected market entity, the selected market topic, or the keyword, respectively. Each content location identifier is thus paired with a market entity identifier, a market topic identifier, a keyword, or a keyphrase and stored as an entry in the master index.

The method 400 may also include formulating a query, at block 478. MRM information may be used to formulate some queries. The method 400 may further include executing the query against the master index, against the MRM, or against an external index, at block 482. One or more returned content location identifiers may be received in response to the query, at block 486. The method 400 may also include retrieving one or more content segments, market entity identifiers, market topic identifiers, and/or market relationship identifiers, at block 490. The method 400 may further include presenting the content segments, market entity identifiers, market topic identifiers, or market relationship identifiers to a user, at block 492.

In some embodiments, the method 400 may also include modifying the MRM according to feedback data derived from the content extraction operations using the MRM, user feedback based upon extraction operations using the MRM, a market event, and/or a market research data point, at block 496.

The activities described herein may be executed in an order other than the order described. The various activities described with respect to the methods identified herein may also be executed in repetitive, serial, and/or parallel fashion.

A software program may be launched from a computer-readable medium in a computer-based system to execute functions defined in the software program. Various programming languages may be employed to create software programs designed to implement and perform the methods disclosed herein. The programs may be structured in an object-oriented format using an object-oriented language such as Java or C++. Alternatively, the programs may be structured in a procedure-oriented format using a procedural language, such as assembly or C. The software components may communicate using a number of mechanisms well-known to those skilled in the art, such as application program interfaces or inter-process communication techniques, including remote procedure calls. The teachings of various embodiments are not limited to any particular programming language or environment.

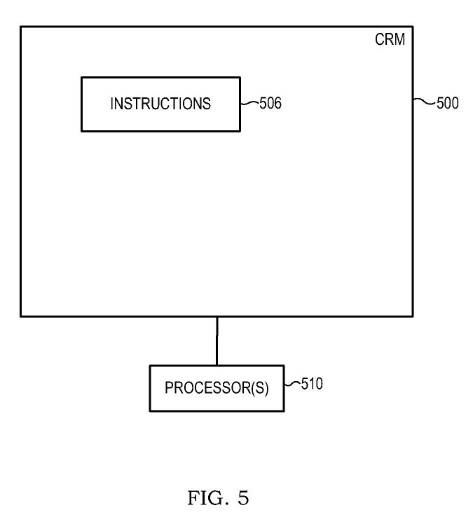

FIG. 5 is a block diagram of a computer-readable medium (CRM) 500 according to various embodiments of the invention. Examples of such embodiments may comprise a memory system, a magnetic or optical disk, or some other storage device. The CRM 500 may contain instructions 506 which, when accessed, result in one or more processors 510 performing any of the activities previously described, including those discussed with respect to the method 400 noted above.

The apparatus, systems, and methods disclosed herein operate to identify and categorize unstructured data according to a user's specific needs and interests according to an IRM. Identifiers associated with relevant market entities, market topics, and keywords are indexed along with content segment location identifiers. Each content segment location identifier points to a location where a content segment containing one or more relevant market entities, market topics, or keywords may be found. Queries, including queries formulated using elements from the IRM, may be executed against the relevant content index. Using these structures, the embodiments may improve content breadth and recall in a scalable manner as compared to results obtained with traditional search engines.

The accompanying drawings that form a part hereof show, by way of illustration and not of limitation, particular embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefor, is not to be taken in a limiting sense. The scope of various embodiments is defined by the appended claims and the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments and other embodiments not specifically described herein will be apparent to those of skill in the art upon reviewing the above description.

The Abstract of the Disclosure is provided to comply with 37 C.F.R. § 1.72(b) requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. An apparatus, comprising:
a market relationship module (MRM) including a market entity dataset, a market topic dataset, a market relationship dataset, and a set of semantic rules, the MRM to relate at least one of a plurality of market entities, a plurality of market topics, or at least one market entity and at least one market topic according to at least one market relationship;
a content processor coupled to the MRM to receive unstructured information content and to parse the unstructured information content into a plurality of selected content segments, each selected content segment related to at least one of a selected market entity, a selected market topic, or a keyword, wherein selected content segments related to the selected market entity and to the selected market topic are parsed according to the MRM, and to index a location identifier associated with the selected content segment by at least one of an identifier associated with the selected market entity, an identifier associated with the selected market topic, or the keyword; and
a master index coupled to the content processor to store the indexed location identifier and at least one of the identifier associated with the selected market entity, the identifier associated with the selected market topic, or the keyword.

2. The apparatus of claim 1, wherein the MRM comprises at least one of a relational database, an eXtensible Markup Language (XML) schema, an object oriented database, a semantic database, or a resource description framework (RDF) data store.

3. The apparatus of claim 1, wherein the at least one market relationship comprises a dynamic market relationship.

4. The apparatus of claim 1, wherein the MRM is configured to store a dynamic market relationship established in response to a market event after initially loading the MRM.

5. The apparatus of claim 1, wherein the MRM is configured to store a dynamic market relationship established if a frequency of coincidence between at least one of two market entities, two market topics, or a market entity and a market topic found in at least one of the plurality of selected content segments increases past a selected threshold.

6. The apparatus of claim 1, wherein the MRM is configured to store a new market topic synthesized from at least one of the plurality of market topics or the at least one market entity and the at least one market topic and wherein at least one of the plurality of market topics or the at least one market entity and the at least one market topic is provided at query time.

7. The apparatus of claim 1, wherein the MRM is configured to store a new market entity synthesized from at least one of the plurality of market entities or the at least one market entity and the at least one market topic and wherein at least one of the plurality of market topics or the at least one market entity and the at least one market topic is provided at query time.

8. The apparatus of claim 1, wherein each selected content segment comprises at least one of a content file, a portion of the content file, a tag associated with the content file, or a result of a translation operation performed on the content file.

9. The apparatus of claim 8, wherein the content file comprises at least one of a markup language page, a text file, a word processing file, a graphics file, a video file, an audio file, a spreadsheet file, a slide presentation file, or a page description file.

10. The apparatus of claim 1, wherein the content processor is configured to extract the selected content segment from at least one of an internet, an intranet, a database, a library, or a content stream.

11. The apparatus of claim 1, wherein the content processor is configured to receive the selected content segment from at least one of a linked content crawling engine or a content stream filter.

12. The apparatus of claim 1, wherein the location identifier associated with each selected content segment comprises at least one of a uniform resource locator (URL), a file location, or a location of a portion of a file within the file.

13. The apparatus of claim 1, further comprising:
an MRM administrative graphical user interface (GUI) communicatively coupled to the MRM to receive the market entity dataset, the market topic dataset, the market relationship dataset, and the set of semantic rules.

14. The apparatus of claim 1, further comprising:
a market entity loading module coupled to the MRM to load the market entity dataset and a subset of semantic rules associated with a plurality of market entity representations contained in the market entity dataset;
a market topic loading module coupled to the MRM to load the market topic dataset and a subset of semantic rules associated with a plurality of market topic representations contained in the market topic dataset; and
a market relationship loading module coupled to the MRM to load the market relationship dataset.

15. The apparatus of claim 1, further comprising:
an MRM loading application programming interface (API) to load at least one of the market entity dataset, the market topic dataset, the market relationship dataset, or the set of semantic rules from an interprocess communications source.

16. The apparatus of claim 1, wherein the content processor is configured to associate at least one content segment offset with each selected market entity, selected market topic, or keyword, and wherein the at least one content segment offset corresponds to a position of an occurrence of the selected market entity, selected market topic, or keyword within the selected content segment.

17. The apparatus of claim 16, wherein the at least one content segment offset comprises at least one of a position of a word, a position of a sentence, a position of a paragraph, or a position of a section of the selected content segment.

18. The apparatus of claim 1, wherein the master index comprises a keyword index, a market entity index, and a market topic index.

19. The apparatus of claim 18, wherein each entry within the keyword index comprises at least one of a keyword, a keyphrase, a corresponding content location identifier, and at least one content segment offset, wherein the keyword or keyphrase is extracted from at least one of the plurality of selected content segments, and wherein each of the plurality of selected content segments is located at a content location corresponding to an associated content location identifier.

20. The apparatus of claim 18, further including:
a keyword association metric value stored in the keyword index, the keyword association metric value calculated based upon at least one of a frequency of occurrence of the keyword in the selected content segment, a presence of the keyword in a headline associated with the selected content segment, an occurrence of the keyword with greater prominence than surrounding text, an occurrence of the keyword in a caption associated with a picture found within the selected content segment, or a presence of the keyword in anchor text.

21. The apparatus of claim 18, wherein each entry within the market entity index comprises at least one of a market entity identifier, a corresponding content location identifier, and at least one content segment offset, wherein the market entity identifier corresponds to a market entity selected using the MRM and referred to by at least one of the plurality of selected content segments, and wherein each of the plurality of selected content segments is located at a content location corresponding to an associated content location identifier.

22. The apparatus of claim 18, wherein each entry within the market topic index comprises at least one of a market topic identifier, a corresponding content location identifier, and at least one content segment offset, wherein the market topic identifier corresponds to a market topic selected using the MRM and referred to by at least one of the plurality of selected content segments, and wherein each of the plurality of selected content segments is located at a content location corresponding to an associated content location identifier.

23. The apparatus of claim 1, wherein the master index is configured to store a strength-of-association metric value corresponding to at least one of the selected market entity or the selected market topic, the strength-of-association metric value to indicate relatedness between the selected market entity and the selected content segment or the selected market topic and the selected content segment, wherein the strength-of-association metric value is computed using the set of semantic rules and is based upon at least one of a frequency of occurrence of at least one keyword indicative of the market entity or the market topic in the selected content segment, a presence of the at least one keyword in a headline associated with the selected content segment, an occurrence of the at least one keyword with greater prominence than surrounding text, an occurrence of the at least one keyword in a caption associated with a picture found within the selected content segment, or a presence of the at least one keyword in anchor text.

24. The apparatus of claim 1, wherein the master index is configured to store an impact metric value associated with at least one of an impacted market entity or an impacted market topic, the impact metric value to indicate a relative importance of the selected content segment to the impacted market entity or the impacted market topic, wherein the impact metric value is calculated using the set of semantic rules and comprises a composite score based upon at least one of a pre-defined assessment of a financial impact of an impacting market entity or market topic found in the selected content segment on the impacted market entity or on the impacted market topic, an occurrence in the selected content segment of an impacting market entity pre-defined as high impact, an occurrence in the selected content segment of an impacting market topic pre-defined as high impact, an occurrence in the selected content segment of an impacting market entity-keyword pair, wherein the impacting market entity-keyword pair is pre-defined as high impact, an occurrence in the selected content segment of an impacting market topic-keyword pair wherein the impacting market-topic keyword pair is predefined as high impact, an occurrence in the selected content segment of multiple key market entities, an occurrence in the selected content segment of multiple key market topics, or authorship of the selected content segment by a member of a predefined list of individuals determined through research to be at least one of a member of management, a thought leader, or an influential person in an industry.

25. The apparatus of claim 1, further comprising:
a linked content crawling engine coupled to the content processor to navigate among a plurality of linked content sources, to extract a crawled plurality of content segments from the plurality of linked content sources, and to present the crawled plurality of content segments to the content processor.

26. The apparatus of claim 1, further comprising:
a content stream filter coupled to the content processor to extract a filtered plurality of content segments and to present the filtered plurality of content segments to the content processor.

27. A system, comprising:
a market relationship module (MRM) including a market entity dataset, a market topic dataset, a market relationship dataset, and a set of semantic rules, the MRM to relate at least one of a plurality of market entities, a plurality of market topics, or at least one market entity and at least one market topic according to at least one market relationship;
a content processor coupled to the MRM to receive unstructured information content and to parse the unstructured information content into a plurality of selected content segments, each selected content segment related to at least one of a selected market entity, a selected market topic, or a keyword, wherein the selected content segments related to the selected market entity and to the selected market topic are parsed according to the MRM, and to index a location identifier associated with the selected content segment by at least one of an identifier associated with the selected market entity, an identifier associated with the selected market topic, or the keyword;
a master index coupled to the content processor to store the indexed location identifier and at least one of the identifier associated with the selected market entity, the identifier associated with the selected market topic, or the keyword; and
an MRM feedback module communicatively coupled to the MRM to modify the MRM according to at least one of feedback data derived from content retrieval operations using the MRM, user feedback based upon a result of the retrieval operations using the MRM, at least one market event, or at least one market research data point.

28. A method, comprising:
relating at least one of a plurality of market entities, a plurality of market topics, or at least one market entity and at least one market topic according to at least one market relationship in a market relationship module (MRM).

29. The method of claim 28, wherein each of the plurality of market entities comprises at least one of a company, a subsidiary, a joint venture, a product brand, a service brand, a product application, a service application, a non-profit organization, an advocacy group, a region, a governmental sub-division, a person, a raw material, or a component.

30. The method of claim 28, wherein each of the plurality of market entities comprises at least one of a plant or a location associated with at least one of a company, a subsidiary, a joint venture, a product brand, a service brand, a product application, a service application, a non-profit organization, an advocacy group, a region, or a governmental sub-division.

31. The method of claim 28, wherein each of the plurality of market topics comprises at least one of a geo-political market topic, a financial market topic, a corporate market topic, a macroeconomic market topic, a regulatory market topic, or a thematic market topic.

32. The method of claim 28, wherein the market relationship comprises at least one of customer, competitor, supplier, partner, subsidiary, parent company, merger and acquisition target, investor, regulator, banker, financier, employee, labor, lobbying group, advocacy group, industry consortium, union, management team member, director, thought leader, financial analyst, industry analyst, division, office, plant, producer, seller, development resource, embedded resource, place of operation, key market, or location of unit.

33. The method of claim 28, further comprising:
selectively establishing the market relationship as at least one of unidirectional or bidirectional.

34. The method of claim 28, further comprising:
selecting a first set of companies corresponding to an industry using a standard industry classification system;
narrowing the first set of companies to a second set of companies, wherein the second set of companies share a common market theme;
adding a company classified under a different industry to the second set of companies if the company classified under the other industry shares the common market theme; and
adding an unclassified company to the second set of companies if the unclassified company shares the common market theme.

35. The method of claim 28, further comprising:
creating a user-personalized MRM as a subset of the MRM.

36. The method of claim 28, further comprising:
receiving a set of market entity data; and
loading a market entity dataset associated with the MRM with the set of market entity data.

37. The method of claim 28, further comprising:
receiving a set of market topic data; and
loading a market topic dataset associated with the MRM with the set of market topic data.

38. The method of claim 28, further comprising:
receiving a set of market relationship data; and
loading a market relationship dataset associated with the MRM with the set of market relationship data.

39. The method of claim 28, further comprising:
receiving a set of semantic rules; and
loading the set of semantic rules into the MRM.

40. The method of claim 28, further comprising:
modifying the MRM according to at least one of feedback data derived from content extraction operations using the MRM, user feedback based upon extraction operations using the MRM, at least one market event, or at least one market research data point.

41. A method, comprising:
receiving unstructured information content;
parsing the unstructured information content into a plurality of selected content segments; and
relating each of the plurality of selected content segments to at least one of a selected market entity, a selected market topic, or a keyword, the selected content segments related to the selected market entity and to the selected market topic using an MRM.

42. The method of claim 41, further comprising:
indexing a location identifier associated with at least one of the plurality of selected content segments by at least one of an identifier associated with the selected market entity, an identifier associated with the selected market topic, or the keyword; and
storing the indexed location identifier associated with the at least one selected content segment in a master index.

43. The method of claim 42, further comprising:
formulating a query;
executing the query against at least one of the master index and the MRM;
receiving at least one returned content location identifier in response to the query;
retrieving at least one of a content segment, a market entity identifier, a market topic identifier, or a market relationship identifier; and
presenting the at least one of a content segment, a market entity identifier, a market topic identifier, or a market relationship identifier to a user.

44. The method of claim 41, further including:
associating at least one content segment offset with each selected market entity, selected market topic, or keyword, wherein the at least one content segment offset corresponds to a position of an occurrence of the selected market entity, selected market topic, or keyword within the selected content segment; and
storing the at least one content segment offset in a master index.

45. The method of claim 44, wherein the at least one content segment offset comprises at least one of a position of a word, a position of a sentence, a position of a paragraph, or a position of a section of the selected content segment.

46. The method of claim 41, further including:
calculating a strength-of-association metric value corresponding to at least one of the selected market entity or the selected market topic, the strength-of-association metric value to indicate relatedness between the selected market entity and the selected content segment or the selected market topic and the selected content segment; and
storing the strength-of-association metric value in a master index.

47. The method of claim 46, wherein the strength-of-association metric value is computed using a set of semantic rules and is based upon at least one of a frequency of occurrence of at least one keyword indicative of the market entity or the market topic in the selected content segment, a presence of the at least one keyword in a headline associated with the selected content segment, an occurrence of the at least one keyword with greater prominence than surrounding text, an occurrence of the at least one keyword in a caption associated with a picture found within the selected content segment, or a presence of the at least one keyword in anchor text.

48. The method of claim 41, further including:
calculating an impact metric value associated with at least one of an impacted market entity or an impacted market topic, wherein the impact metric value indicates a relative importance of the selected content segment to the impacted market entity or the impacted market topic; and
storing the impact metric value in a master index.

49. The method of claim 48, wherein the master index is configured to store an impact metric value associated with at least one of an impacted market entity or an impacted market topic, the impact metric value to indicate a relative importance of the selected content segment to the impacted market entity or the impacted market topic, wherein the impact metric value is calculated using a set of semantic rules and comprises a composite score based upon at least one of a pre-defined assessment of a financial impact of an impacting market entity or market topic found in the selected content segment on the impacted market entity or on the impacted market topic, an occurrence in the selected content segment of an impacting market entity pre-defined as high impact, an occurrence in the selected content segment of an impacting market topic pre-defined as high impact, an occurrence in the selected content segment of an impacting market entity-keyword pair, wherein the impacting market entity-keyword pair is pre-defined as high impact, an occurrence in the selected content segment of an impacting market topic-keyword pair wherein the impacting market-topic keyword pair is predefined as high impact, an occurrence in the selected content segment of multiple key market entities, an occurrence in the selected content segment of multiple key market topics, or authorship of the selected content segment by a member of a predefined list of individuals determined through research to be at least one of a member of management, a thought leader, or an influential person in an industry.

50. The method of claim 41, further comprising:
calculating a keyword association metric value, wherein the keyword association metric value is based upon at least one of a frequency of occurrence of the keyword in the selected content segment, a presence of the keyword in a headline associated with the selected content segment, an occurrence of the keyword with greater prominence than surrounding text, an occurrence of the keyword in a caption associated with a picture found within the selected content segment, or a presence of the keyword in anchor text; and
storing the keyword association metric value in the keyword index.

51. The method of claim 41, further comprising:
navigating among a plurality of linked content sources; and
extracting a plurality of content segments from the plurality of linked content sources using a linked content crawling engine.

52. The method of claim 41, further comprising:
filtering a content stream to extract a plurality of content segments; and
presenting the plurality of content segments as a set of unstructured information content.

53. A computer-readable medium having instructions, wherein the instructions, when executed, result in at least one processor performing:
relating at least one of a plurality of market entities, a plurality of market topics, or at least one market entity and at least one market topic according to at least one market relationship to create a market relationship module (MRM);
receiving unstructured information content; and
parsing the unstructured information content into a plurality of selected content segments according to the MRM, each of the plurality of selected content segments related to at least one of a selected market entity, a selected market topic, or a keyword.

54. The computer-readable medium of claim 53, wherein the instructions, when executed, result in the at least one processor performing:
indexing a location identifier associated with at least one selected content segment by at least one of an identifier associated with the selected market entity, an identifier associated with the selected market topic, or the keyword; and
storing the indexed location identifier associated with the at least one selected content segment in a master index.

55. The computer-readable medium of claim 54, wherein the instructions, when executed, result in the at least one processor performing:
formulating a query;
executing the query against at least one of the master index and the MRM;
receiving at least one returned content location identifier in response to the query;
retrieving at least one of a content segment, a market entity identifier, a market topic identifier, or a market relationship identifier; and
presenting the at least one of a content segment, a market entity identifier, a market topic identifier, or a market relationship identifier to a user.
